(19) United States
(12) Patent Application Publication
(10) Pub. No.: US 2015/0356353 A1
(43) Pub. Date: Dec. 10, 2015

(54) METHOD FOR IDENTIFYING OBJECTS IN AN AUDIOVISUAL DOCUMENT AND CORRESPONDING DEVICE

(71) Applicant: THOMSON LICENSING, Issy-les-Moulineaux (FR)

(72) Inventors: Jean-Ronan VIGOUROUX, Rennes (FR); Alexey OZEROV, Rennes (FR); Louis CHEVALLIER, La Meziere (FR)

(21) Appl. No.: 14/760,196

(22) PCT Filed: Jan. 9, 2014
(86) PCT No.: PCT/EP2014/050277

§ 371 Date: Jul. 9, 2015

(30) Foreign Application Priority Data
Jan. 10, 2013 (EP) 13305018.7
Jul. 17, 2013 (EP) 13306022.8

(51) Int. Cl. G06K 9/00; G06K 9/62; H04N 21/44; G10L 15/08

(52) U.S. Cl. CPC G06K 9/00718; G10L 15/08; G06K 9/622; G06K 9/6215; H04N 21/44008

(57) ABSTRACT

The invention relates to the technical field of recognition of objects in audiovisual documents. The method uses multimodal data that is collected and stored in a similarity matrix. A level of similarity is determined for each matrix cell. Then a clustering algorithm is applied to cluster the information comprised in the similarity matrix. Clusters are identified, each identified cell cluster identifying an object in the audiovisual document.

### 1. FIELD OF INVENTION

The present invention relates to the technical field of recognition of objects (humans, material objects) in audiovisual documents.

### 2. TECHNICAL BACKGROUND

In the domain of recognition of entities such as particular movie actors or particular objects in audiovisual documents, there is a recent and growing interest for methods that alleviate the need for manual annotation, which is a costly and time-consuming process. Automatic object recognition in audio visual documents is useful in many applications that require searching in an audiovisual document data base. Current methods exploit techniques that are for example described in document “Association of Audio and Video Segmentations for Automatic Person Indexing”, El Khoury, E.; Jaffre, G.; Pinquier, J.; Senac, C.; Content-Based Multimedia Indexing, 2007. CBMI '07. However current methods do not extend to a large set of modalities or complementary information, such as audiovisual document script in textual form, pictures, audio track or subtitles. Not using this complementary information means that occasions are lacked to deduce supplementary information by crosschecking/correlating of information from multiple information sources.

It would therefore be desirable to present a unifying scheme which enables to take into account many kinds of information that can serve as a basis for object recognition in audiovisual documents.

### 3. SUMMARY OF THE INVENTION

One purpose of the present invention is to solve some of the problems occurring with prior art. To this end, there is provided a method for identifying objects in an audiovisual document, comprising collecting multimodal data related to the audiovisual document; creating a similarity matrix for the multimodal data, where each modality of the multimodal data is attributed a column and a row; determining, for each cell in the similarity matrix, a level of similarity between a corresponding column data item and a corresponding row data item; clustering cells in the similarity matrix by seriating the similarity matrix; and identifying cell clusters within the similarity matrix by detection of low similarity levels in a first lower or upper sub diagonal of the similarity matrix that delimits a zone of similarity levels that are higher than the low similarity levels, whereby each identified cell cluster identifies an object in the audiovisual document. The method advantageously allows taking into account multiple modalities in order to provide a particularly efficient method for identifying objects in an audiovisual document.

According to a variant embodiment of the invention, each of the modality of the multimodal data is of at least one of the following types: image, text, audio data, or video. This variant embodiment, by taking into account different types of multimodal data, adds further to the pertinence of the identification of objects in an audiovisual document.

According to a further variant embodiment, the multimodal data is obtained from at least one of: an image data base, a textual description of the audiovisual document, a speech recording of an entity occurring in the audiovisual document, or a face tube being a video sequence of an actor occurring in the audiovisual document. This variant embodiment, by taking into account different information sources for providing the multimodal data, adds further to the pertinence of the identification of objects in an audiovisual document.

According to a further variant embodiment, the multimodal data comprises temporal information. This variant embodiment advantageously allows to temporally relating the identified object to the audiovisual document.

The invention also concerns a device for identifying objects in an audiovisual document, the device comprising a multimodal data collector for collecting multimodal data related to the audiovisual document; a similarity matrix creator for creating a similarity matrix for the multimodal data, where each modality of the multimodal data is attributed a column and a row; a similarity determinator for determining, for each cell in the similarity matrix, a level of similarity between a corresponding column data item and a corresponding row data item; a matrix seriator for clustering cells in the similarity matrix by seriating the similarity matrix; a cell cluster identificator for identifying cell clusters within the similarity matrix by detection of low similarity levels in a first lower or upper sub diagonal of the similarity matrix that delimits a zone of similarity levels that are higher than the low similarity levels; whereby each identified cell cluster identifies an object in the audiovisual document.

The discussed advantages and other advantages not mentioned in this document will become clear upon the reading of the detailed description of the invention that follows.

In the following, the term ‘audiovisual’ or ‘audio/video’ is used, meaning audio alone, video alone, or a combination of audio and video. In the following, the term ‘document’ or ‘content’ is used, meaning the same. In the following, the wording “audiovisual document” is used, meaning a digital data stream comprising video and/or audio information, a digital data file comprising video and/or audio data, such as a movie, documentary, news broadcast, or video clip. In the following, the term ‘object’ is used in the context of contents of an audiovisual document comprising objects, meaning a movie character, an actor, an animal, a building, a car, grass, trees or clouds, that occur in the audiovisual document.

### 4. LIST OF FIGURES

More advantages of the invention will appear through the description of particular, non-restricting embodiments of the invention. The embodiments will be described with reference to the following figures:

FIG. 1 illustrates the different sources of information and types of information that can be related to an audiovisual document.

FIG. 2 shows an example of a seriation for simple data.

FIG. 3 shows an example of a seriation for more complex data.

FIG. 4 is a flow chart of a particular embodiment of the method of the invention.

FIG. 5 is a device implementing the method of the invention.

### 5. DETAILED DESCRIPTION OF THE INVENTION

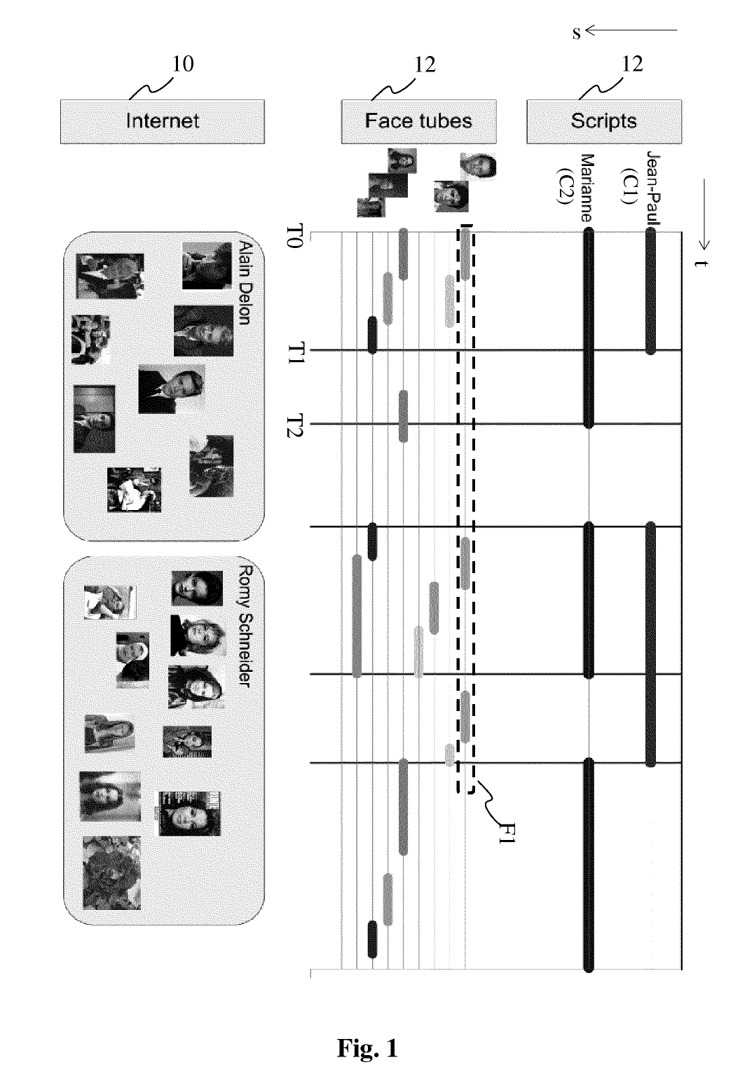

FIG. 1 illustrates the different sources of information and types of information that can be related to an audiovisual document.

The information is said to be multimodal, that is, being of different modalities, e.g. a face tube F1, an audio tube A1, a character tube C1 in a script. A modality is of a type such as image, text, audio, video, the list not being exhaustive, the modalities being obtained from different sources of information for the multimodal data as shown in the figure: scripts, audio tubes, face tubes and Internet images, the list not being exhaustive. Some of the multimodal data may comprise temporal information that allows to temporally relating the multimodal data to the audiovisual document in which objects are to be identified, such as scripts, audio tubes and face tubes, while others are not temporally related, such as still images from the Internet. In the context of the invention, an audio tube or a face tube is a sequence of audio extracts or faces in an audiovisual document that supposedly belongs to a same entity (e.g. actor, movie character, animal, material object) appearing in the audiovisual document. A script in the context of the invention is a textual document that describes the unrolling of the audiovisual document and includes dialog and instructions for production of the audiovisual document and is also referred to as screenplay.

The figure illustrates the multimodality of the data that can be related to the audiovisual document: script data, face tube data and image data from Internet. Character ‘Jean-Paul’ (C1) figures in the script of audiovisual document from T0 to T1, and that character ‘Marianne’ (C2) figures in the script of audiovisual document from T0 to T2, which information is obtained from the script. Row “Face tube” depicts some face tubes (F1-F5) of images of characters that are visible in the audiovisual document at several moments in time. Row “Internet” illustrates non-temporal related images found on the Internet, that are for example found after a search related to names of the principal actors in the audiovisual document.

The process of relating script to audiovisual document or how face tubes are detected or how Internet images are found is done using known prior art methods and is therefore out of scope of the present invention.

Table 1 hereunder an example of a construction of a so-called similarity matrix according to the invention. A similarity matrix is a distance matrix, representing in its cells the distances between the various sources of information (data items) that make up the rows and columns of the matrix. A similarity matrix is a particular kind of distance matrix, where the matrix cells comprise values expressing a level of similarity between the row and column data items. Per definition, a similarity matrix is a square (or block, or n×n) matrix, i.e. that has the same number of rows and columns; the cells comprise real, non-negative numbers, the cell values are bounded (for example between 0 and 1), the matrix is reflexive (all diagonal cells are filled with 1s), and symmetrical, meaning that for all cells, a cell ij is mirrored by a cell ji having the same value. Similarity matrixes are data structures known in technical domains such as Information Retrieval (IR) and bioinformatics. In the following similarity matrix, the data items that are ordered in rows and columns represent characters appearing in a script and face tubes.

TABLE 1
Example of a similarity matrix according to the invention

| | C1 | C2 | C3 | F1 | F2 | F3 |
|---|---|---|---|---|---|---|
| C1 | 1 | 0 | 0 | S | ε | ε |
| C2 | 0 | 1 | 0 | ε | S | ε |
| C3 | 0 | 0 | 1 | ε | ε | ε |
| F1 | S | ε | ε | 1 | ε | ε |
| F2 | ε | S | ε | ε | 1 | ε |
| F3 | ε | ε | ε | ε | ε | 1 |

As can be observed, each modality of the multimodal data is attributed a column and a row in the similarity matrix. Modalities C1-C3 represent different script characters that appear in the script. Modalities F1-F3 are the different face tubes that can be recognized in the audiovisual document. In our example, modality “face tube F3” corresponds to a background actor. A rule is established to normalize the similarity levels, for example a predetermined range is defined, where 0 stands for minimum similarity (e.g. completely different) and 1 stands for maximum similarity (=the same). 0 and 1 values can be determined when constructing the similarity matrix; for example, it can be determined with absolute sureness that modality “character C1” corresponds to modality “character C1”, and also that modality “character C1” does not correspond to modality “character C2”. Intermediate values are represented by “S” or “ε” for respectively a high similarity level and a low similarity level between modalities. These values can be calculated with known prior art methods for determining similarity, that are out of scope of the present invention and that are therefore not further described in detail. For example, one can use a method to determine the similarity between the faces in a face tube and a part of a script (i.e. a ‘script tube’) using a Jaccard coefficient of similarity. Similarity between audio tubes and scripts, or between audio tubes and visual tubes, can be defined in the same way. Similarity between face tubes and images collected on the Internet can be based on the minimum of the face similarity between the faces in the tube and the faces in the collection of images related to an actor. Similarity between audio tubes and Internet images may be set to the minimum similarity (no information) or may be set to an intermediate value if for instance gender information is available for the actor and for voices in the audiovisual document, as the gender information can be used to match an actor to a voice. Similarity levels between scripts and Internet images may be computed using casting information available in the script, providing normally a one to one correspondence between the script characters and the actors in the audiovisual document.

Note that this similarity matrix is not ordered and that it cannot be deducted easily from this similarity matrix that for example face tube F1 corresponds to the actor Alain Delon that corresponds to movie character Jean-Paul (C1) in the audiovisual document. Clustering of the similarity matrix will allow recognizing patterns in the information that is still dispersed in the similarity matrix. Clustering can be done in different ways, for example by spectral clustering, or matrix seriation. Matrix seriation has proved to give better performances. Rows and columns that correspond to a same modality have an average similarity between them that is smaller than the average similarity of rows and columns corresponding to different characters.

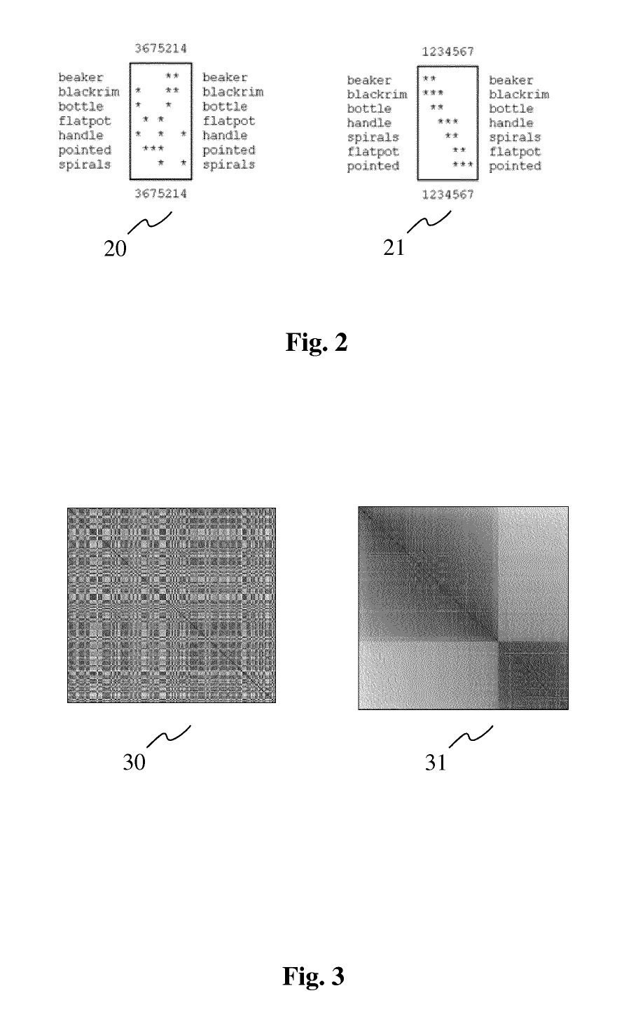

FIG. 2 shows an example of a seriation for simple data. Seriation is a matrix permutation technique which is among others used in archeology for relative dating of objects. The objective is to permute the rows and the columns of the matrix to cluster lines and rows (and thus cells). For example, the similarity levels between data corresponding a same actor or character can be expected to be in average greater than the similarity levels between data corresponding to different actors or characters.

A possible known seriation method that can be used in the present invention is for example based on computing a Hamiltonian path. A distance between a line i and a line i+1 is noted as being dist (sᵢ, sᵢ₊₁). The length of a Hamiltonian path is the sum of the sub-diagonal dist (sᵢ, sᵢ₊₁) where i={1 to n−1}. The heuristic to solve the problem is a Kruskal like algorithm which favors the growth of compact and short paths and that merges when no other option is left.

The example of FIG. 2 is related to serial ordering of Egyptian pottery. Item 20 illustrates raw data, and item 21 illustrates seriated data. The words represent design styles found on the pottery. The numbers represent contexts in which the potteries were found. From the seriation, patterns may be deducted such as in the present case different types of design styles that are related to particular contexts.

FIG. 3 shows an example of a seriation for more complex data and represents a more realistic situation in which the help of a computer program is welcome. Item 30 illustrates a similarity matrix before seriation. Item 31 illustrates a similarity matrix after seriation.

Now, using the process of seriation to permute the rows and columns of the similarity matrix, patterns can be discovered that allows to crosscheck/correlate the data and relate the columns and rows between them, and thus to relate the information in the matrix so as to identify cell clusters. A cell cluster identifying an object in the audiovisual document, objects can now be recognized in the audiovisual document. Using the previous example of Table 1, Table 2 hereunder illustrates Table 1 after seriation.

TABLE 2
Table 1 after seriation

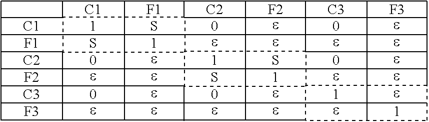

After the seriation, one can recognize a pattern in the table, where related information is regrouped/clustered in the cells that are surrounded by broken lines. The clustering of information allows to determine further information, namely identification of objects in the audiovisual document.

For example, from the script and the face tubes, it can be deduced with relative certainty that face tube F1 corresponds to character C1 in the script, and that face tube F2 corresponds to character C2 in the script. It can be further deduced that face tube F3 does most probably not correspond to any of the characters in the script, i.e. F3 corresponds with a high probability to a background actor.

While these patterns can be recognized visually in the similarity matrix as depicted above, the method of the invention provides a machine-operable way to identify cell clusters in the similarity matrix by determining limits between the patterns as is illustrated in Table 3 hereunder.

TABLE 3
Machine-operable method for identification of cell clusters

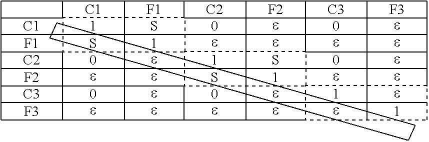

By searching for the diagonal next under (or next above) the diagonal of the seriated similarity matrix, it is possible to detect low levels of similarity that are between zones of high level of similarity.

An algorithm for identifying (or creating) the clusters is described hereafter.

The first step is to the find the threshold which enables to separate consecutive clusters. To this we:
First collect the N−1 numbers in the sub-diagonal. These numbers are sorted in an ascending order.
Second determine the threshold. If the number of clusters is known in advance (for instance if the number of main and secondary characters are known) the threshold is set to the n−1 th number in the array (supposing the first index is 1). For instance to divide the sub-diagonal in three clusters the second number is selected to obtain two separations. Alternatively, if the number of clusters is not known, the number is selected using classical means for this kind of problems, such as looking for the presence of an inflexion point in the ordered array, or looking for the first point under the means of the values minus some standard deviations of the value.

The second step is to sweep through the subdiagonal of the seriated matrix, and identifying/creating a first cluster at the first cell. For each line i in the matrix the label of the line that is added to the current cluster is the value of the cell c_{i i+1} is over the threshold. It the value of the cell is under the threshold the current cluster is closed and a new empty cluster is opened (i.e. a cluster has been identified).

In the end a set of clusters is obtained, which are sets of labels of the lines or columns of the seriated matrix. All the labels in a cluster are expected to be related to a single character in the movie.

A zone of high level similarity is thus delimited by a cell of low level of similarity. The high level zones thus regroup/cluster the information in the similarity matrix in cell clusters. Each of the cell clusters thus identified by the machine-operable method described above then identifies an object in the audiovisual document. For example, it can now be said with relative high certainty (S) that face tube F1 corresponds to character C1 in the script, that face tube F2 corresponds to character C2 in the script, etc. Object face tube F1 is thus identified as corresponding to script character C1, and object face tube F2 is identified as corresponding to script character C2. If the multimodal data comprises information that allows to temporally relate the multimodal data to the audiovisual document, it can also be determined from the identified cell clusters that face tube F1 is that of script character C1 that appears multiple times in the audiovisual document at the time stamps given by the temporal information associated to the face tube F1; also refer to FIG. 1.

For reasons of simplicity of presentation, the similarity matrixes depicted in tables 1 to 3 only comprise two modalities (face tubes and script characters). The reader of the present document will understand that the invention is not limited to two modalities, and that other modalities can be added to the matrixes depicted in tables 1-3 without diverting from the principle of the invention.

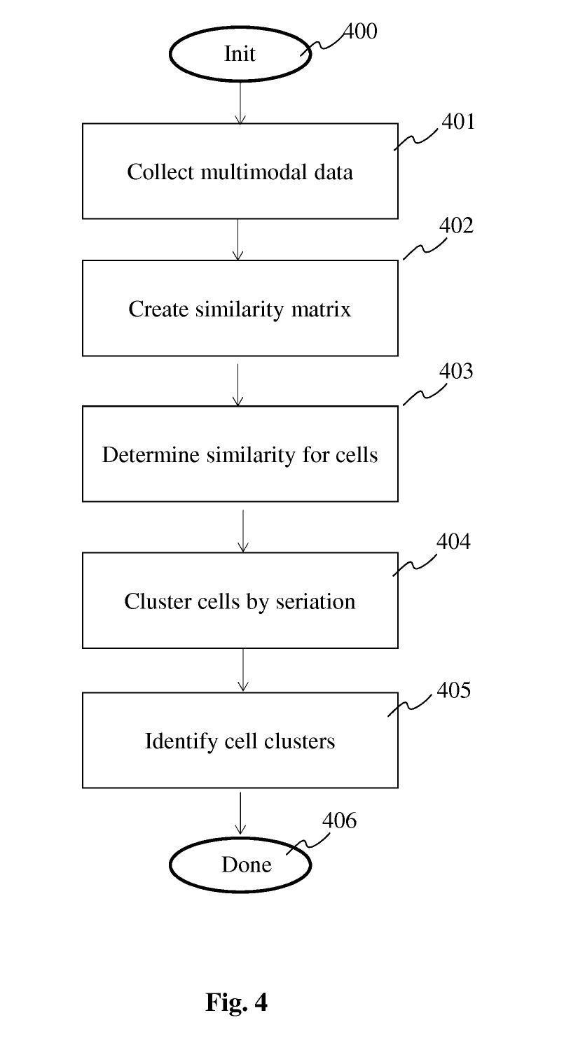

FIG. 4 illustrates a flow chart of a particular embodiment of the method of the invention.

In a first initialization step 400, variables are initialized for the functioning of the method. This step comprises for example copying of data from non-volatile memory to volatile memory and initialization of memory. In a step 401, multimodal data is collected which data is related to an audiovisual document in which an object is to be identified. Collecting the multimodal data is for example done by means of a machine search in one or more databases or on the Internet. In a step 402, a similarity matrix is created for the multimodal data, where each modality of the multimodal data is attributed a row and a column in the matrix, such as one row and one column for a particular face tube F1 in the audiovisual document and the same for a particular character C1 in a script. Then, in a step 403, a level of similarity is determined between column and row data and the determined similarity level is stored in the corresponding cell. Then, in a step 404, the cells of the similarity matrix are clustered using seriation as previously discussed. In a step 405, cell clusters are identified in the matrix by iterating over the cells in a lower or upper diagonal that is next to the diagonal of the matrix, and detecting levels of similarity that are low with regard to surrounding similarity levels (i.e. search for local minima). The detected low levels are representative for cell cluster boundaries, the cell clusters that are thus determined regroup/cluster coherent information that each cell cluster identifying an object in the audiovisual document. This is a machine operable step that was previously explained with the help of table 3. The method stops with step 406.

The flow chart of FIG. 4 is for illustrative purposes and the method of the invention is not necessarily implemented as such. Other possibilities of implementation comprise a parallel execution of steps or a batch execution.

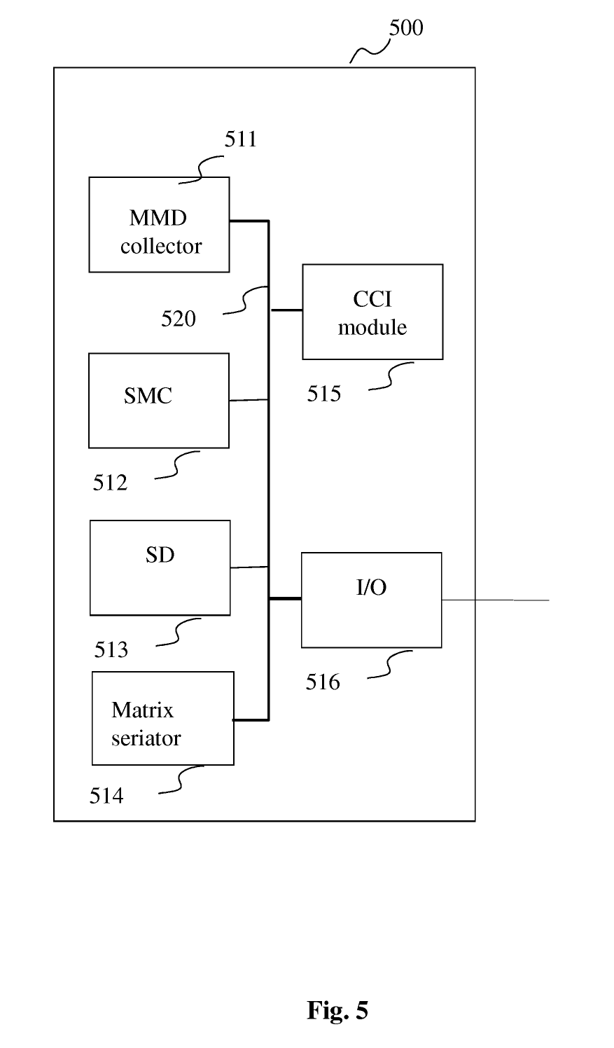

FIG. 5 shows an example of a device implementing the invention. The device 500 comprises the following components, interconnected by a digital data- and address bus 520:
a multimodal data collector 511 (or MMD collector);
a similarity matrix creator 512 (SMC);
a similarity determining 513 (SD);
a matrix seriator 514;
a cell cluster identificator 515 (CCI);
and an I/O interface 516 for communication with the outside world.

According to a variant embodiment of the device according to the invention, the device comprises generic hardware with specific software for implementing the different functions that are provided by the steps of the method.

Other device architectures than illustrated by FIG. 5 are possible and compatible with the method of the invention. Notably, according to variant embodiments, the invention is implemented as a pure hardware implementation, for example in the form of a dedicated component (for example in an ASIC, FPGA or VLSI, respectively meaning Application Specific Integrated Circuit, Field-Programmable Gate Array and Very Large Scale Integration), or in the form of multiple electronic components integrated in a device or in the form of a mix of hardware and software components, for example as a dedicated electronic card in a computer, each of the means implemented in hardware, software or a mix of these, in same or different soft- or hardware modules.

The present method and device can be used for several applications such as selective retrieval of a sequence of audio/video data, characterizing of audio/video data, or audio/video data indexing, or applications that take advantage of user preferences that are determined from audiovisual documents that the user likes, such as personalization of an offer of a web store, personalization of a Video on Demand offering, personalization of a streaming radio channel.

The present invention can be implemented in various devices such as a digital set top box, a digital television decoder, a digital television, a digital still camera, a digital video camera, a smartphone, a tablet, a personal computer, or any other device capable of processing audiovisual documents.

1-5. (canceled)

6. A method for identifying objects in an audiovisual document, wherein the method is implemented by a device, the method comprising:
collecting items of multimodal data related to the audiovisual document;
temporally relate said items of multimodal data to said audiovisual document, by relating temporal information comprised in said items of multimodal data to temporal information comprised in said audiovisual document;
creating a similarity matrix for the items of multimodal data, where each item of multimodal data is attributed a column and a row;
determining, for each cell in the similarity matrix, a level of similarity between a corresponding column data item and a corresponding row data item, said level of similarity being computed using a method specific to a modality type of the column data item and the row data item if the column data item and the row data item are of a same modality type, or using a Jaccard coefficient if the column data item and the row data item are of a different modality type;
clustering cells in the similarity matrix by seriating the similarity matrix;
identifying cell clusters within the similarity matrix by detection of low similarity levels in a first lower or upper sub diagonal of the similarity matrix that delimits a zone of similarity levels that are higher than the low similarity levels;
whereby each identified cell cluster identifies an object in the audiovisual document.

7. The method according to claim 6, wherein said modality type is at least one of the following types: image, text, audio data, or video.

8. The method according to claim 6, wherein the items of multimodal data are obtained from at least one of: an image data base, a textual description of the audiovisual document, a speech recording of an entity occurring in the audiovisual document, or a face tube being a video sequence of an actor occurring in the audiovisual document.

9. A device for identifying objects in an audiovisual document, the device being characterized in that it comprises:
a multimodal data collector for collecting items of multimodal data related to the audiovisual document;
means for temporally relating said items of multimodal data to said audiovisual document, by relating temporal information comprised in said items of multimodal data to temporal information comprised in said audiovisual document;
a similarity matrix creator for creating a similarity matrix for the items of multimodal data, where each item of multimodal data is attributed a column and a row;
a similarity determinator for determining, for each cell in the similarity matrix, a level of similarity between a corresponding column data item and a corresponding row data item, said level of similarity being computed using a method specific to a modality type if the column data item and the row data item are of a same modality type, or using a Jaccard coefficient if the column data item and the row data item are of a different modality type;
a matrix seriator for clustering cells in the similarity matrix by seriating the similarity matrix;
a cell cluster identificator for identifying cell clusters within the similarity matrix by detection of low similarity levels in a first lower or upper sub diagonal of the similarity matrix that delimits a zone of similarity levels that are higher than the low similarity levels;
whereby each identified cell cluster identifies an object in the audiovisual document.

10. The method according to claim 7, wherein the items of multimodal data are obtained from at least one of: an image data base, a textual description of the audiovisual document, a speech recording of an entity occurring in the audiovisual document, or a face tube being a video sequence of an actor occurring in the audiovisual document.
